(19) United States
(12) Patent Application Publication
(10) Pub. No.: US 2025/0174000 A1
(43) Pub. Date: May 29, 2025

(54) GENERATING DATA ITEMS USING OFF-THE-SHELF GUIDED GENERATIVE DIFFUSION PROCESSES

(71) Applicant: DeepMind Technologies Limited, London (GB)

(72) Inventors: Conor Michael Durkan, New York, NY (US); Sander Etienne Lea Dieleman, London (GB); Mikolaj Binkowski, London (GB); Wenling Shang, Hackensack, NJ (US)

(21) Appl. No.: 18/834,184

(22) PCT Filed: Jan. 30, 2023
(86) PCT No.: PCT/EP2023/052186

§ 371 Date: Jul. 29, 2024

Related U.S. Application Data
(60) Provisional application No. 63/304,567, filed on Jan. 28, 2022.

(51) Int. Cl. G06V 10/72; G06T 11/60; G06V 10/26; G06V 10/764; G06V 10/82

(52) U.S. Cl. CPC G06V 10/72; G06T 11/60; G06V 10/26; G06V 10/764; G06V 10/82

(57) ABSTRACT

Methods, systems, and apparatus, including computer programs encoded on computer storage media, for generating a data item using a diffusion neural network. In particular, the data item is generated by guiding a reverse diffusion process using a time-independent guidance neural network.

### BACKGROUND

This specification relates to generating outputs conditioned on conditioning inputs using neural networks.

Neural networks are machine learning models that employ one or more layers of nonlinear units to predict an output for a received input. Some neural networks include one or more hidden layers in addition to an output layer. The output of each hidden layer is used as input to or more other layers in the network, i.e., one or more other hidden layers, the output layer, or both. Each layer of the network generates an output from a received input in accordance with current values of a respective set of parameters.

### SUMMARY

This specification describes a system implemented as computer programs on one or more computers in one or more locations that generates an output data item conditioned on a conditioning input.

Generally, the conditioning input characterizes one or more desired properties for the data item, i.e., characterizes one or more properties that the final data item generated by the system should have.

More specifically, the system generates the output data item by guiding a trained diffusion neural network using a guidance neural network that is used, at each updating iteration of a reverse diffusion process, to determine a likelihood that the current data item has a property that is derived from the conditioning input. The guidance neural network is generally a pre-trained neural network that is time-independent, i.e., does not receive as input any data identifying the current updating iteration.

In one aspect, a method includes initializing a data item; receiving a conditioning input characterizing one or more desired properties for the data item; updating the data item to generate a final data item having the one or more desired properties, the updating comprising, at each of a plurality of updating iterations: generating, from the conditioning input, a target output for the updating iteration; identifying a current data item as of the updating iteration; processing a diffusion input for the updating iteration that comprises the current data item using a diffusion neural network to generate a denoising output for the updating iteration; determining, using the current data item and the denoising output for the updating iteration, a set of one or more estimates of the final data item; processing a respective guidance input for each of the estimates in the set using a guidance neural network to generate, for each of the estimates in the set, a respective likelihood for the target output for the updating iteration; determining a first gradient with respect to the current data item of a likelihood term that is dependent on the respective likelihoods for the target outputs for each of the estimates in the set; and updating the current data item using the first gradient and the denoising output. By using the denoising output to generate the estimate(s) and then processing guidance inputs for the estimates, e.g., instead of for the current (noisy) data item, the system ensures that an off-the-shelf guidance neural network can be used to generate likelihoods that accurately “guide” the generation of the final data item.

In some implementations, the diffusion input for the updating iteration comprises data identifying the updating iteration.

In some of these implementations, the respective guidance inputs for the estimates do not include any data identifying the updating iteration. That is, the guidance neural network is an off-the-shelf neural network that does not need to be specially trained to process time-conditional inputs.

In some implementations, the set of one or estimates comprises a plurality of estimates.

In some of these implementations, determining, using the current data item and the denoising output for the updating iteration, the set of estimates of the final data item comprises: determining, using the current data item and the denoising output for the updating iteration, an initial estimate of the final data item; and generating a plurality of estimates from the initial estimate by applying one or more data augmentations for the updating iteration to the initial estimate.

In some implementations, the method further includes randomly generating the one or more data augmentations for the updating iteration.

In some implementations, the likelihood term is equal to a logarithm of a product of the respective likelihoods for the plurality of estimates in the set.

In some implementations, updating the current data item using the first gradient and the denoising output comprises: normalizing the first gradient to generate a normalized first gradient that has a unit norm; and updating the current data item using the normalized first gradient and the denoising output.

In some implementations, the target output is the same for each updating iteration and identifies a probability of one that the current data item as of the updating iteration has the one or more desired properties.

In some implementations, the conditioning output identifies a class from a plurality of classes to which the target output should belong, and the guidance neural network is a classifier that processes an input data item to generate a respective likelihood for each of the plurality of classes.

In some implementations, the final data item is an image, the conditioning output identifies a target segmentation for the final data item, and the guidance neural network is a segmentation neural network that processes an input image to generate a segmentation output for the target output.

In some implementations, the final data item is an image, the conditioning output identifies a target caption for the final data item, and the guidance neural network is a captioning neural network that processes an input image to generate a caption output for the target output.

In some implementations, the guidance neural network is pre-trained prior to training the diffusion neural network and is held fixed during training of the diffusion neural network. In some implementations, initializing the data item comprises sampling each value in the data item from a noise distribution.

In some implementations, the data item is an image, an audio waveform, or a sensor output.

In some implementations, the data item is an image, the conditioning input specifies a class from a plurality of object classes, and the guidance neural network is an image classification neural network that classifies images into a plurality of object classes. In some of these implementations, the object classes are semantic types.

In some implementations, updating the current data item using the first gradient and the denoising output comprises: determining a time-dependent score estimate from the first gradient and the denoising output; and applying a stochastic differential equation (SDE) solver to the time-dependent score estimate to update the current data item.

In some of these implementations, determining a time-dependent score estimate from the first gradient and the denoising output comprises: multiplying (i) the first gradient or (ii) a normalized version of the first gradient by a scaling factor to generate a scaled first gradient; determining a denoising update from (i) the denoising output and (ii) an output of a time-dependent function of the updating iteration; and computing a sum of the scaled first gradient and the denoising update.

The subject matter described in this specification can be implemented in particular embodiments so as to realize one or more of the following advantages.

The described techniques generate output data items conditioned on conditioning inputs. Previously, guiding generative diffusion processes, i.e., processes that generate data items using diffusion neural networks, often requires separate time-dependent guidance terms, which therefore requires training a specific, time-dependent guidance neural network. This requires additional training resources and computational resources. The described techniques eliminate this requirement by exploiting pre-trained models, i.e., by removing the requirement that the guidance neural network be time-dependent, allowing an already high-performing neural network to be used to effectively guide the generation process, without any fine-tuning or retraining.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example data generation system.

FIG. 2 is a flow diagram of an example process for generating an output data item.

FIG. 3 is a flow diagram of an example process for determining one or more estimates of the final data item.

Like reference numbers and designations in the various drawings indicate like elements.

### DETAILED DESCRIPTION

This specification describes a system implemented as computer programs on one or more computers in one or more locations that generates an output data item conditioned on a conditioning input.

Generally, the conditioning input characterizes one or more desired properties for the data item, i.e., characterizes one or more properties that the final data item generated by the system should have.

The system can be configured to generate any of a variety of output data items conditioned on any of a variety of conditioning inputs.

For example, the system can be configured to generate audio data, e.g., a waveform of audio or a spectrogram, e.g., a mel-spectrogram or a spectrogram where the frequencies are in a different scale, of the audio.

In this example, the conditioning input can be text or features of text that the audio should represent, i.e., so that the system serves as a text-to-speech machine learning model that converts text or features of the text to audio data for an utterance of the text being spoken.

As another example, the conditioning input can identify a desired speaker for the audio, i.e., so that the system generates audio data that represents speech by the desired speaker.

As another example, the conditioning input can specify a classification for the audio data into a class from a set of possible classes, so that the system generates audio data that belongs to the class. For example, the classes can represent types of musical instruments or other audio emitting devices, i.e., so that the system generates audio that is emitted by the corresponding class, types of animals, i.e., so that the system generates audio that represent noises generated by the corresponding animal, and so on.

As another particular example, the data item can be an image, such that the system can perform conditional image generation by generating the intensity values of the pixels of the image.

In this particular example, the conditioning input can be a sequence of text and the output data item can be an image that describes the text, i.e., the conditioning input can be a caption for the output image.

As yet another particular example, the conditioning input can be an object detection input that specifies one or more bounding boxes and, optionally, a respective type of object that should be depicted in each bounding box.

As yet another particular example, the conditioning input can specify an object class from a plurality of object classes to which an object depicted in the output image should belong.

As yet another particular example, the conditioning input can specify an image at a first resolution and the output data item can comprise the image at a second, higher resolution.

As yet another particular example, the conditioning input can specify an image and the output data item can comprise a de-noised version of the image.

As yet another particular example, the conditioning input can specify an image including a target entity for detection, e.g. a tumor, and the output data item can comprise the image without the target entity, e.g. to facilitate detection of the target entity by comparing the images.

As yet another particular example, the conditioning input can be a segmentation that assigns each of a plurality of pixels of the output image to a category from a set of categories, e.g., that assigns to each pixel a respective one of the category.

More generally, the task can be any task that outputs continuous data conditioned on a conditioning input. For example, the output can be an output of a different sensor, e.g., a lidar point cloud, a radar point cloud, an electrocardiogram reading, and so on, and the conditioning input can represent the type of data that should be measured by the sensor. Where a discrete output is desired this can be obtained, e.g. by thresholding.

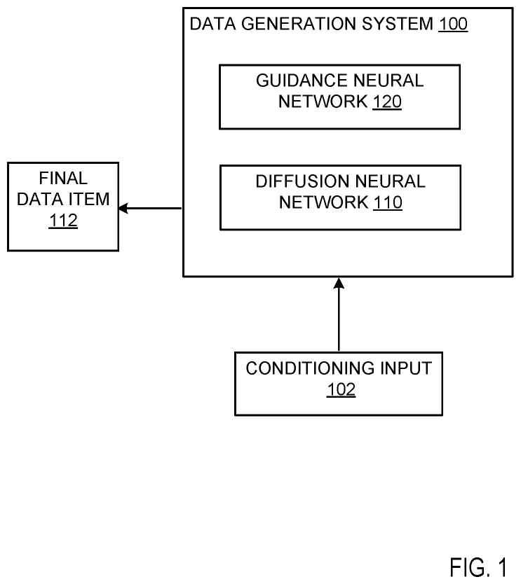

FIG. 1 is a diagram of an example data generation system 100. The data generation system 100 is an example of a system implemented as computer programs on one or more computers in one or more locations, in which the systems, components, and techniques described below can be implemented.

The system 100 obtains a conditioning input 102 and uses the conditioning input 102 to generate an output data item 112 that has the one or more desired properties characterized by the conditioning input 102.

In particular, to generate the output data item 112, the system 100 uses a diffusion neural network 110 and a guidance neural network 120 to generate the output data item 112 across multiple updating iterations by performing a reverse diffusion process.

The diffusion neural network 110 can be any appropriate diffusion neural network that has been trained, e.g., by the system 100 or another training system, to, at any given updating iteration, process a diffusion input for the updating iteration that includes the current data item (as of the updating iteration) to generate a denoising output for the updating iteration.

The denoising output is an estimate of the noise that needs to be, e.g., added to a final data item, i.e., to the output data item 112 being generated by the system 100, to generate the current data item.

For example, the diffusion neural network 110 can have been trained on a set of training data items using a denoising score-matching objective to generate the denoising output.

The diffusion neural network 110 can have any appropriate architecture that allows the neural network to map a diffusion input that includes an input data item that has the same dimensionality as the output data item 112 to a diffusion output that also has the same dimensionality as the output data item 112. For example, when the output data item is an audio signal or an image, the diffusion neural network 110 can be a convolutional neural network, e.g., a U-Net or other architecture that maps one input of a given dimensionality to an output of the same dimensionality. As another example, the diffusion neural network 110 can be a Transformer neural network that maps one input of a given dimensionality to an output of the same dimensionality.

In some implementations, the diffusion neural network 110 has been trained as an unconditional diffusion neural network, i.e., so that the diffusion neural network 110 does not receive any conditioning information as input.

In some other implementations, the diffusion neural network 120 has been trained as a class-conditional diffusion neural network, so that the diffusion input at each iteration includes data identifying a class to which the data item 112 should belong. For example, the class can be included in the diffusion input as a one-hot vector identifying the class or as an embedding characterizing the class.

The guidance neural network 120 is a neural network that processes an input data item to generate an output that defines a likelihood that the input data item has the one or more desired properties specified by the conditioning input 102.

For example, when the system 100 is configured to generate audio data, the guidance neural network 120 is an audio processing neural network that processes audio data to generate an output that defines a likelihood that audio has the one or more desired properties.

If the conditioning input 102 is text or features of text that the audio should represent, the guidance neural network 120 can be a speech recognition neural network that generates a transcription of input speech and, therefore, can be used to assign a likelihood to the conditioning input 102.

If the conditioning input 102 specifies a classification for the audio data into a class from a set of possible classes, so that the system 100 generates audio data that belongs to the class, the guidance neural network 120 can be an audio classification neural network that generates a probability distribution over the classes, e.g., speakers, sound emitting objects, musical instruments, animals, and so on.

As another particular example, if the data item 112 is an image, the guidance neural network 120 is an image processing neural network that generates an output that defines a likelihood that the input image has the one or more desired properties.

If the conditioning input 102 is a text caption, the guidance neural network 120 can be an image captioning neural network that processes an image to generate a caption for the image and, therefore, can be used to assign a likelihood to the conditioning input.

If the conditioning input 102 is an object detection input, the guidance neural network 120 can be an object detection neural network that processes an input image to generate an object detection output that specifies one or more bounding boxes and a respective type of object that is depicted in each bounding box.

If the conditioning input 102 specifies an object class from a plurality of object classes to which an object depicted in the output image should belong, the guidance neural network 120 can be an image classification neural network that generates a probability distribution over the object classes.

If the conditioning input 102 is a segmentation that assigns each of a plurality of pixels of the output image to a category from a set of categories, the guidance neural network 120 can be an image segmentation neural network that generates an image segmentation output that assigns a respective probability for each of the categories for each pixel in the image, and can therefore be used to determine the likelihood.

Generally, the guidance neural network 120 has been pre-trained to perform the appropriate task, i.e., is an “off-the-shelf” neural network that is not trained jointly with the diffusion neural network 110 and that is not configured specifically for use as part of a reverse diffusion process. For example, as will be made clear below, the respective guidance inputs processed by the guidance neural network 120 do not include any data identifying the updating iteration that is currently being performed.

Similarly, the diffusion neural network 110 has been trained, e.g., on the score matching objective, independently of the guidance neural network 120. That is, the guidance neural network 120 generally was not used to guide the diffusion process during training of the diffusion neural network 110.

Thus, the system 100 can use any neural network that can be used to map data items to likelihoods of the data items having the properties defined by the conditioning input 102 as the guidance neural network 120.

At each updating iteration, the system 100 uses the diffusion output generated by the diffusion neural network 110 and one or more outputs generated by the guidance neural network 120 to update the current data item as of the updating iteration.

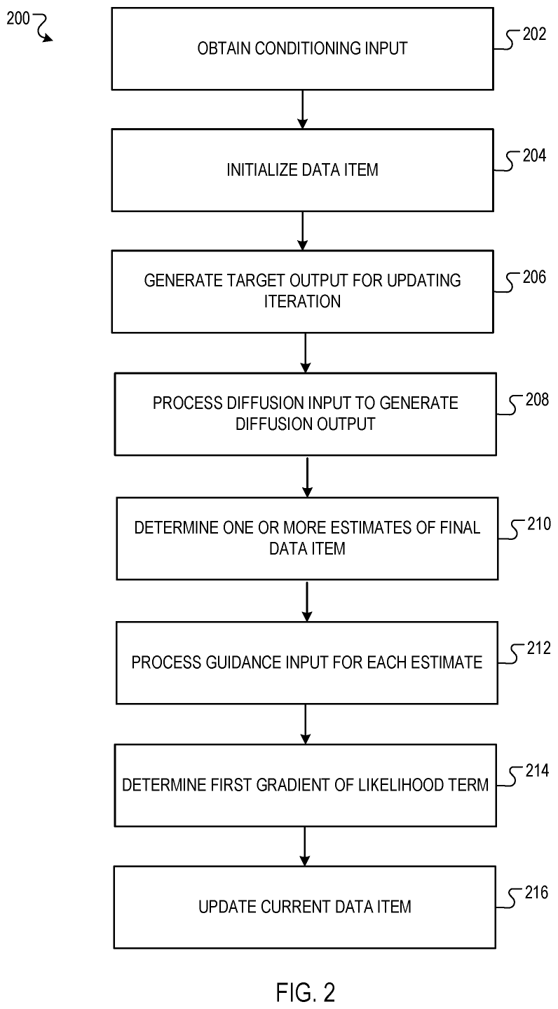

Performing updating iterations is described in more detail below with reference to FIGS. 2-4.

After the last updating iteration, the system 100 outputs the current data item as the final output data item 112.

Because the guidance neural network 120 was used to “guide” the generation process across the updating iteration, the final output data item 112 will have the one or more properties characterized by the conditioning input 102.

For example, the system 100 can provide the data item 112 for presentation or play back to a user on a user computer or store the data item 112 for later use.

FIG. 2 is a flow diagram of an example process 200 for generating a final data item. For convenience, the process 200 will be described as being performed by a system of one or more computers located in one or more locations. For example, a data generation system, e.g., the data generation system 100 depicted in FIG. 1, appropriately programmed in accordance with this specification, can perform the process 200.

The system obtains a conditioning input (step 202). When the diffusion neural network is class-conditioned neural network, the system also obtains data identifying a desired class for the final data item (also referred to as an “output data item”).

The system initializes the data item (step 204).

The initialized data item is the same dimensionality as the final data item but has noisy values.

For example, the system can initialize the data item, i.e., can generate the first instance of the data item, by sampling each value in the data item from a corresponding noise distribution, e.g., a Gaussian distribution, a Normal distribution, or a different noise distribution. That is, the output data item includes multiple values and the initial data item includes the same number of values, with each value being sampled from a corresponding noise distribution.

The system then generates the final output data item by updating the data item at each of a plurality of updating iterations. In other words, the final output data item is the data item after the last iteration of the plurality of updating iterations.

In some cases, the number of iterations is fixed. In other cases, the system or another system can adjust the number of iterations based on a latency requirement for the generation of the final output data item, i.e., can select the number of iterations so that the final output data item will be generated to satisfy the latency requirement. In yet other cases, the system or another system can adjust the number of iterations based on a computational resource consumption requirement for the generation of the final output data item, i.e., can select the number of iterations so that the final output data item will be generated to satisfy the requirement. For example, the requirement can be a maximum number of floating operations (FLOPS) to be performed as part of generating the final output data item.

As described above, the system performs a reverse diffusion process across the updating iterations to update the current data item at each iteration. A reverse diffusion process is defined as:

$$dx = [ f ( x , t ) - {g ( t )}^{2} {∇}_{{x}_{t}} log p ( {x}_{t} ) ] dt - g ( t ) d \overline{w} ,$$

where w̅ is a standard Wiener process with time running in reverse from t=1 to t=0 and each updating iteration corresponding to a different time point, f(x,t) is a drift term, g(t) is a diffusion term, xₜ is the current data item at time point t, and ∇ₓ_{ₜ} log p(xₜ) is a time-dependent score function.

When the guidance neural network (and the conditioning input) are not used, the time-dependent score function is approximated by the diffusion output.

For example,

$${∇}_{{x}_{t}} log p ( {x}_{t} ) \approx {s}_{θ} ( {x}_{t} , t ) = - \frac{{e}_{θ} ( {x}_{t} , t )}{β ( t )} ,$$

where s_{θ}(xₜ,t) is an approximate score function, e_{θ}(xₜ,t) is the diffusion output at the updating iteration corresponding to time index t and β(t) is an integral function of f. As can be seen from the above equation, in some implementations the diffusion input at any given updating iteration also includes data identifying the updating iteration, i.e., by virtue of the diffusion input including data characterizing t. For example, the diffusion input can include the current value of t or an embedding of the current value of t. When the diffusion neural network has been trained as a class-conditional model, the diffusion input at any given iteration can also characterize the data identifying a desired class for the final data item, e.g. as a one-hot encoding of the desired class or an embedding of the desired class.

However, when the conditioning input y is used, the time-dependent score function is also dependent on y and becomes ∇ₓ_{ₜ} log p (xₜ|y). That is, the time-dependent score function now measures how well the current data item represents the conditioning input.

This (conditional) time-dependent score function can be approximated as:

$${∇}_{{x}_{t}} log p ( {x}_{t} \vert y ) \approx γ {∇}_{{x}_{t}} log p ( y \vert {x}_{t} ) + {s}_{θ} ( {x}_{t} , t ) ,$$

where γ is a positive constant, e.g., greater than one, that serves as a temperature for how much the conditional probability contributes to the score estimate at a given time t.

However, directly using the guidance neural network to generate p(y|xₜ) would require the guidance neural network to process the current, noisy data item. Because the guidance neural network is an off-the-shelf model, the training data for the neural network likely included (primarily) “clean,” un-noised data items. Therefore, the current noisy data item is an out-of-distribution input for the guidance neural network and the guidance neural network will likely perform poorly in estimating the likelihood of the conditioning input given the current data item.

As will be described below, the system makes one or more modifications at each updating iteration to account for this and to improve the usefulness of the guidance neural network to the generation process.

In particular, at each updating iteration, the system performs steps 206-212 to update the data item.

The system generates, from the conditioning input, a target output for the updating iteration (step 206).

The target output is an output that should be generated by the guidance neural network at the updating iteration.

As described above, the guidance neural network is a neural network that processes an input data item to generate an output that defines a likelihood that the input data item has the one or more desired properties that are specified by the conditioning input.

In some implementations, the target output is the same for all of the updating iterations and assigns a likelihood of one hundred percent, i.e., a probability of one, to the data item having the desired properties.

In some other implementations, the target output can change throughout the updating iterations. For example, the system can gradually increase the certainty represented by the target output as the iterations progress. As a particular example, the system can increase the certainty, i.e., increase the likelihood indicated by the target output, according to a predefined schedule across the updating iterations.

The system also identifies a current data item as of the updating iteration and processes a diffusion input for the updating iteration that includes the current data item using the diffusion neural network to generate a denoising output for the updating iteration (step 208). As described above, the diffusion input can also include data identifying the updating iteration, data characterizing a desired class for the final data item, or both.

For the first updating iteration, the current data item is the noisy initial data item. For each subsequent updating iteration, the current data item is the data item after the preceding updating iteration.

As described above, the denoising output is an estimate of the noise that needs to be added to the final data item to generate the current data item and that can be used to generate an estimate of the final data item given the current data item.

The system determines, using the current data item and the denoising output for the updating iteration, a set of one or more estimates of the final data item to be used for generating the guiding signal for updating the current data item based on the conditioning input (step 210).

That is, rather than expressing the time-dependent score estimate as γ∇ₓ_{ₜ} log p(y|xₜ)+s_{θ}(xₜ,t), the system instead uses γ∇ₓ_{ₜ} log p(y|Φ(xₜ,t))+s_{θ}(xₜ,t), where φ(xₜ,t) is an estimate of what the final data item should be given the denoising output that was generated at the iteration and the current data item as of the updating iteration.

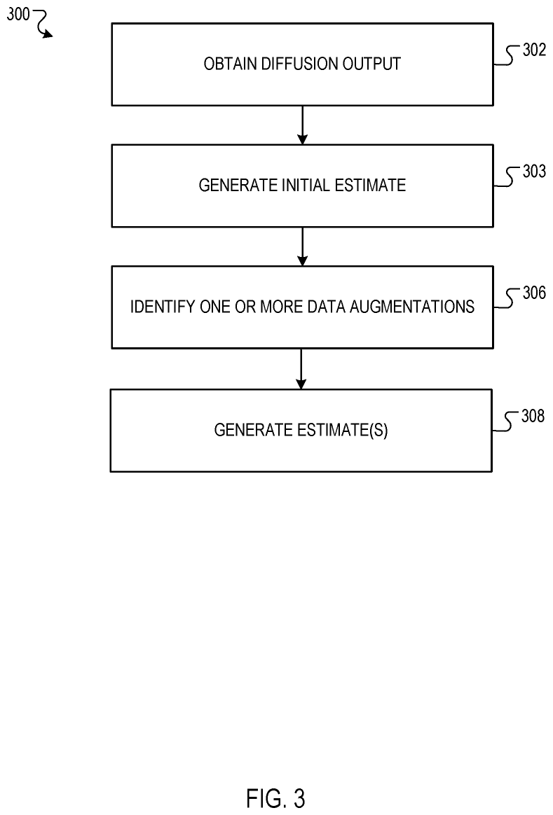

Generating the estimate(s) using the denoising output for the updating iteration is described in more detail below with reference to FIG. 3.

The system processes a respective guidance input for each of the estimates in the set using the guidance neural network to generate, for each of the estimates in the set, a respective likelihood for the target output for the updating iteration (step 212). In general the output generated by the guidance neural network by processing the guidance input guides the form of the final data item, e.g. the appearance of an image or the sound of generated audio data.

That is, the system processes a respective input for each estimate using the guidance neural network and determines the likelihood from the output generated by the guidance neural network for the estimate(s).

More specifically, for each estimate φ(xₜ,t), the system uses the guidance neural network to generate the likelihood p(y|φ(xₜ,t)).

Therefore, rather than processing a current, noisy data item, the guidance neural network instead processes one or more de-noised estimates of the final data item, mitigating the impact of noise on the accuracy of the likelihoods generated by the guidance neural network.

Moreover, the respective guidance inputs for the estimates do not include any data identifying the updating iteration, allowing the system to use an “off-the-shelf”, pre-trained mode instead of needing to train a separate time-conditional guidance neural network.

The system determines a first gradient with respect to the current data item of a likelihood term that is dependent on the respective likelihoods for the target outputs for each of the estimates in the set, e.g., by backpropagating through the guidance neural network and the computation of the estimate(s) from the current data item (step 214).

When there is a single estimate, the first term is, as indicated above, γ∇ₓ_{ₜ} log p(y|φ(xₜ,t)), i.e., based on the logarithm of the likelihood assigned to the target output for the updating iteration by the guidance neural network.

When there are multiple estimates, the system combines the likelihoods assigned to the target output by the guidance network outputs for each of the estimates. For example, the first term can be as above, except that the likelihood for the single estimate is replaced by a product of the respective likelihoods for the plurality of estimates, e.g., so that the first term is based on the logarithm of the product of the respective likelihoods for the plurality of estimates.

The system then updates the current data item using the first gradient and the denoising output (step 216).

In some implementations, as part of using the first gradient to update the current data item, the system normalizes the first gradient to generate a normalized first gradient and then updates the current data item using the normalized first gradient and the denoising output. For example, the system can normalize the first gradient so that the first gradient has a unit norm by dividing the first gradient by the norm of the first gradient.

For example, the system can use the first gradient and the denoising output to generate a time-dependent score estimate and then determine the update from the time-dependent score estimate.

For example, the system can multiply (i) the first gradient or (ii) the normalized version of the first gradient (“normalized first gradient”) by a scaling factor, e.g., the scaling factor γ above, to generate a scaled first gradient and determine a denoising update from (i) the denoising output and (ii) an output of a time-dependent function of the updating iteration, e.g., by dividing the negative of the denoising output by β(t). The system then computes a sum of the scaled first gradient and the denoising update to determine the time-dependent score estimate.

One way the system can use the time-dependent score estimate to update the current data item is by applying a stochastic differential equation (SDE) solver to the time-dependent score estimate to update the current data item.

In such an approach the system can use any appropriate SDE solver to update the current data item. For example, the system can use a SDE solver that employs the Euler-Maruyama method to simulate the reverse-time SDE. As another example, the system can use a SDE solver that employs the Jolicoeur-Martineau method to simulate the reverse-time SDE. As another example, the system can use a stochastic Runge-Kutta method adapted for systems with additive noise.

FIG. 3 is a flow diagram of an example process 300 for generating a set of one or more estimates of the final data item at a given updating iteration. For convenience, the process 300 will be described as being performed by a system of one or more computers located in one or more locations. For example, a data generation system, e.g., the data generation system 100 depicted in FIG. 1, appropriately programmed in accordance with this specification, can perform the process 300.

The system obtains the diffusion output for the updating iteration (step 302), e.g., generated by the diffusion neural network as described above.

The system determines, using the current data item and the denoising output for the updating iteration, an initial estimate of the final data item (step 304).

In particular, the system can compute the initial estimate as:

$$\frac{1}{α ( t )} [ {x}_{t} - β ( t ) {e}_{θ} ( {x}_{t} , t ) ]$$

In some implementations, the system uses the initial estimate as the only estimate in the set of estimates.

In some other implementations, the system identifies one or more data augmentations for the updating iteration (step 306). For example, the system can randomly generate the one or more data augmentations for the updating iteration from a set of possible augmentations.

Examples of augmentations that can be employed by the system include combinations of random scaling, cropping and flipping; for audio these can be applied in the time, frequency, or time-frequency domain. That is, each of the one or more augmentation includes a different set of operations that are performed on a data item to modify the data item.

The system generates the estimates from the initial estimate by applying the one or more data augmentations for the updating iteration to the initial estimate (step 308). When the set of estimates includes a single estimates, the system applies a single augmentation to the initial estimate to generate the single estimate. When the set of estimates includes multiple estimates, the system applies multiple different augmentations to the initial estimate to generate multiple different estimates, i.e., by generating a different estimate for each different augmentation.

Making use of multiple estimates generated by applying augmentations to the initial estimate can help prevent the guidance neural network from guiding the diffusion neural network to generate an “adversarial” output data item, i.e., a data item that is incorrect classified by the guidance neural network as having the desired properties, by exposing the guidance neural network by multiple variations of the data item at each updating iteration.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
initializing a data item;
receiving a conditioning input characterizing one or more desired properties for the data item;
updating the data item to generate a final data item having the one or more desired properties, the updating comprising, at each of a plurality of updating iterations:
generating, from the conditioning input, a target output for the updating iteration;
identifying a current data item as of the updating iteration;
processing a diffusion input for the updating iteration that comprises the current data item using a diffusion neural network to generate a denoising output for the updating iteration;
determining, using the current data item and the denoising output for the updating iteration, a set of one or more estimates of the final data item;
processing a respective guidance input for each of the estimates in the set using a guidance neural network to generate, for each of the estimates in the set, a respective likelihood for the target output for the updating iteration;
determining a first gradient with respect to the current data item of a likelihood term that is dependent on the respective likelihoods for the target outputs for each of the estimates in the set; and
updating the current data item using the first gradient and the denoising output.

2. The method of claim 1, wherein the diffusion input for the updating iteration comprises data identifying the updating iteration.

3. The method of claim 2, wherein the respective guidance inputs for the estimates do not include any data identifying the updating iteration.

4. The method of claim 1, wherein the set of one or estimates comprises a plurality of estimates.

5. The method of claim 4, wherein determining, using the current data item and the denoising output for the updating iteration, a set of one or more estimates of the final data item comprises:
determining, using the current data item and the denoising output for the updating iteration, an initial estimate of the final data item; and
generating a plurality of estimates from the initial estimate by applying one or more data augmentations for the updating iteration to the initial estimate.

6. The method of claim 5, further comprising:
randomly generating the one or more data augmentations for the updating iteration.

7. The method of claim 4, wherein the likelihood term is equal to a logarithm of a product of the respective likelihoods for the plurality of estimates in the set.

8. The method of claim 1, wherein updating the current data item using the first gradient and the denoising output comprises:
normalizing the first gradient to generate a normalized first gradient that has a unit norm; and
updating the current data item using the normalized first gradient and the denoising output.

9. The method of claim 1, wherein the target output is the same for each updating iteration and identifies a probability of one that the current data item as of the updating iteration has the one or more desired properties.

10. The method of laim 1, wherein the conditioning output identifies a class from a plurality of classes to which the target output should belong, and wherein the guidance neural network is a classifier that processes an input data item to generate a respective likelihood for each of the plurality of classes.

11. The method of claim 1, wherein the final data item is an image, the conditioning output identifies a target segmentation for the final data item, and wherein the guidance neural network is a segmentation neural network that processes an input image to generate a segmentation output for the target output.

12. The method of claim 1, wherein the final data item is an image, the conditioning output identifies a target caption for the final data item, and wherein the guidance neural network is a captioning neural network that processes an input image to generate a caption output for the target output.

13. The method of claim 1, wherein the guidance neural network is pre-trained prior to training the diffusion neural network and is held fixed during training of the diffusion neural network.

14. The method of claim 1, wherein initializing the data item comprises sampling each value in the data item from a noise distribution.

15. The method of claim 1, wherein the data item is an image, an audio waveform, or a sensor output.

16. The method of claim 1, wherein the data item is an image, the conditioning input specifies a class from a plurality of object classes, and the guidance neural network is an image classification neural network that classifies images into a plurality of object classes.

17. The method of claim 16, wherein the object classes are semantic types.

18. The method of claim 1, wherein updating the current data item using the first gradient and the denoising output comprises:
determining a time-dependent score estimate from the first gradient and the denoising output; and
applying a stochastic differential equation (SDE) solver to the time-dependent score estimate to update the current data item.

19. The method of claim 18, wherein determining a time-dependent score estimate from the first gradient and the denoising output comprises:
multiplying (i) the first gradient or (ii) a normalized version of the first gradient by a scaling factor to generate a scaled first gradient;
determining a denoising update from (i) the denoising output and (ii) an output of a time-dependent function of the updating iteration; and
computing a sum of the scaled first gradient and the denoising update.

20. A system comprising one or more computers and one or more storage devices storing instructions that are operable, when executed by the one or more computers, to cause the one or more computers to perform operations comprising:
initializing a data item;
receiving a conditioning input characterizing one or more desired properties for the data item;
updating the data item to generate a final data item having the one or more desired properties, the updating comprising, at each of a plurality of updating iterations:
generating, from the conditioning input, a target output for the updating iteration;
identifying a current data item as of the updating iteration;
processing a diffusion input for the updating iteration that comprises the current data item using a diffusion neural network to generate a denoising output for the updating iteration;
determining, using the current data item and the denoising output for the updating iteration, a set of one or more estimates of the final data item;
processing a respective guidance input for each of the estimates in the set using a guidance neural network to generate, for each of the estimates in the set, a respective likelihood for the target output for the updating iteration;
determining a first gradient with respect to the current data item of a likelihood term that is dependent on the respective likelihoods for the target outputs for each of the estimates in the set; and
updating the current data item using the first gradient and the denoising output.

21. A computer storage medium encoded with instructions that, when executed by one or more computers, cause the one or more computers to perform operations comprising:
initializing a data item;
receiving a conditioning input characterizing one or more desired properties for the data item;
updating the data item to generate a final data item having the one or more desired properties, the updating comprising, at each of a plurality of updating iterations:
generating, from the conditioning input, a target output for the updating iteration;
identifying a current data item as of the updating iteration;
processing a diffusion input for the updating iteration that comprises the current data item using a diffusion neural network to generate a denoising output for the updating iteration;
determining, using the current data item and the denoising output for the updating iteration, a set of one or more estimates of the final data item;
processing a respective guidance input for each of the estimates in the set using a guidance neural network to generate, for each of the estimates in the set, a respective likelihood for the target output for the updating iteration;
determining a first gradient with respect to the current data item of a likelihood term that is dependent on the respective likelihoods for the target outputs for each of the estimates in the set; and
updating the current data item using the first gradient and the denoising output.
